(19) United States
(12) Patent Application Publication
(10) Pub. No.: US 2026/0134261 A1
(43) Pub. Date: May 14, 2026

(54) COMMUNICATION METHOD AND COMMUNICATION APPARATUS

(71) Applicant: Huawei Technologies Co., Ltd., Shenzhen (CN)

(72) Inventors: Yiqun Ge, Ottawa (CA); Hao Tang, Ottawa (CA); Jianglei Ma, Ottawa (CA)

(21) Appl. No.: 19/415,058

(22) Filed: Dec. 10, 2025

Related U.S. Application Data
(63) Continuation of application No. PCT/CN2023/125046, filed on Oct. 17, 2023.
(60) Provisional application No. 63/507,767, filed on Jun. 13, 2023.

(51) Int. Cl. G06N 3/0455; H04L 41/16; H04W 24/02

(52) U.S. Cl. CPC G06N 3/0455; H04L 41/16; H04W 24/02

(57) ABSTRACT

Embodiments of the present application provide a communication method and communication apparatus. The communication method includes: receiving first information indicating Q reference distribution(s) corresponding to Q layer(s) of a first AI model; and obtaining a second AI model based on q reference distribution(s) in the Q reference distribution(s).

### CROSS-REFERENCE TO RELATED APPLICATIONS

The present application is a continuation of International Application No. PCT/CN2023/125046, filed on Oct. 17, 2023, which claims priority to U.S. Provisional Patent Application No. 63/507,767, filed on Jun. 13, 2023.

The disclosures of the aforementioned applications are hereby incorporated by reference in their entirety.

### TECHNICAL FIELD

Embodiments of the present application relate to the field of communications, and more specifically, to a communication method and a communication apparatus.

### BACKGROUND

Artificial intelligence (AI)-based algorithms have been introduced into wireless communications to solve some wireless problems such as channel estimation, scheduling, channel state information (CSI) compression, positioning, beam-management, and so on. AI algorithm is a data-driven method that tunes some pre-defined architectures by a set of data samples called a training data set.

The learning performance of an AI model is crucial for its application. For example, a plurality of AI models deployed on different devices may need to work together. However, the AI models may be trained independently by different providers, making it difficult to ensure the training quality, which may result in the AI models not working together.

Therefore, an urgent technical problem that needs to be solved is how to improve the learning performance of the AI model.

### SUMMARY

Embodiments of the present application provide a communication method and a communication apparatus. The technical solutions may improve the learning performance of an AI model.

According to a first aspect, an embodiment of the present application provides a communication method, including receiving first information indicating Q reference distribution(s) corresponding to Q layer(s) of a first AI model, where Q is a positive integer; and obtaining a second AI model based on q reference distribution(s) in the Q reference distribution(s), where q is a positive integer, q≤Q.

According to the above technical solution, the second AI model is obtained according to the q reference distribution(s), which is conducive to shaping the q layer(s) of the second AI model according to the q reference distribution. In this way, reference distribution(s) can be set as needed to obtain the required AI model, which is beneficial to improving the training performance of the AI model.

Optionally, a reference distribution may be in a form of the parameterized standard distribution.

Optionally, a reference distribution may be in a form of a combination of multiple parameterized standard distributions.

Optionally, a reference distribution may be in a form of a plurality of reference data samples.

In a possible design, the obtaining a second AI model based on q reference distribution(s) in the Q reference distribution(s), includes: obtaining the second AI model with one or more regularizations configured to minimize difference(s) between the q reference distribution(s) and distribution(s) of corresponding q layer(s) in the Q layer(s).

According to the above technical solution, the q layer(s) of the second AI model can be shaped by the q reference distribution(s), which is conducive to achieving the interconnection of multiple AI models. For example, q reference distribution(s) may be consistent with the output of the q layer(s) in the other AI model, which needs to work with the second AI model. According to the above technical solution, the distribution of q layer(s) in the second AI model can be as close as possible to the distribution of q layer(s) in the other AI model, which is conducive to achieving interconnection between the two AI models.

In a possible design, the method further includes: sending second information indicating optimization result(s) of the one or more regularizations.

In a possible design, the Q layer(s) includes one or more latent layers of the first AI model.

In a possible design, the q layer(s) may include one or more latent layers of the first AI model.

Optionally, the q layer(s) may be q latent layer(s) of the first AI model.

Further, the q layer output(s) may include at least one latent layer output, in which case, the at least one latent layer output can be shaped based on the reference distribution(s).

In a possible design, the method further includes: receiving third information indicating the Q layer(s).

In a possible design, the method further includes: receiving fourth information indicating Q scoring function(s) configured to measure difference(s) between the Q reference distribution(s) and distribution(s) of the Q layer(s).

According to a second aspect, an embodiment of the present application provides a communication device, including: obtaining Q reference distribution(s) corresponding to Q layer(s) of a first AI model, where the Q reference distribution(s) is configured to obtain a second AI model, and Q is a positive integer; and sending first information indicating the Q reference distribution(s).

In a possible design, the Q reference distribution(s) is configured to set up one or more regularizations configured to minimize difference(s) between the Q reference distribution(s) and distribution(s) of the Q layer(s).

In a possible design, the method further includes: receiving second information indicating optimization result(s) of the one or more regularizations.

In a possible design, the Q layer(s) includes one or more latent layers of the first AI model.

In a possible design, the method further includes: receiving third information indicating the Q layer(s).

In a possible design, the method further includes: receiving fourth information indicating Q scoring function(s) configured to measure difference(s) between the Q reference distribution(s) and distribution(s) of the Q layer(s).

According to a third aspect, a communication apparatus is provided. The communication apparatus includes a function or unit configured to perform the method according to the first aspect or any one of the possible designs of the first aspect.

For example, the communication apparatus may be a network device or a chip in the network device. For another example, the communication apparatus may be a terminal device or a chip in the terminal device.

According to a fourth aspect, a communication apparatus is provided. The communication apparatus includes a function or unit configured to perform the method according to the second aspect or any one of the possible designs of the second aspect.

For example, the communication apparatus may be a terminal device or a chip in the terminal device. For another example, the communication apparatus may be a network device or a chip in the network device.

According to a fifth aspect, a system is provided. The system includes: the communication apparatus according to the third aspect and the communication apparatus according to the fourth aspect.

According to a sixth aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs the method in any one of the first aspect or the possible designs of the first aspect, or the communication apparatus performs the method in any one of the second aspect or the possible designs of the second aspect.

For example, the communication apparatus may be a network device or a component (for example, a chip or integrated circuit) installed in the network device. For another example, the communication apparatus may be a terminal device or a component (for example, a chip or integrated circuit) installed in the terminal device.

According to a seventh aspect, a communication apparatus is provided. The communication apparatus includes a processor and a communications interface. The processor is connected to the communications interface. The processor is configured to execute the one or more instructions, and the communications interface is configured to communicate with other network elements under the control of the processor. The processor is enabled to perform the method according to the first aspect or any one of the possible designs of the first aspect, or the second aspect or any one of the possible designs of the second aspect.

According to an eighth aspect, a computer storage medium is provided. The computer storage medium stores program code, and the program code is used to execute one or more instructions for the method according to the first aspect or any one of the possible designs of the first aspect, or the second aspect or any one of the possible designs of the second aspect.

According to a ninth aspect, the present application provides a computer program product including one or more instructions, where when the computer program product runs on a computer, the computer performs the method according to the first aspect or any one of the possible designs of the first aspect, or the second aspect or any one of the possible designs of the second aspect.

### DESCRIPTION OF DRAWINGS

FIG. 1 is a schematic diagram of an application scenario according to the present application;

FIG. 2 illustrates an example communication system 100;

FIG. 3 illustrates an example device in the communication system;

FIG. 4 is a schematic diagram of a device in two cycles according to an embodiment of the present application;

FIG. 5 illustrates example local data of a device according to an embodiment of the present application;

FIG. 6 is a schematic diagram of an example scenario;

FIG. 7 is a schematic flowchart of a communication method according to an embodiment of the present application;

FIG. 8 is a schematic diagram of an example regularization on the distribution of one latent layer output according to an embodiment of the present application;

FIG. 9 is a schematic diagram of an example training process of AE according to an embodiment of the present application;

FIG. 10 is a schematic diagram of another example training process of AE according to an embodiment of the present application; and

FIGS. 11-15 are schematic block diagrams of possible devices according to embodiments of the present application.

### DESCRIPTION OF EMBODIMENTS

The following describes technical solutions of the present application with reference to the accompanying drawings.

The embodiments of the present invention may be applied to communication systems of next generation (e.g., sixth generation (6G) or later), 5th Generation (5G), new radio (NR), long term evolution (LTE), or the like.

FIG. 1 is a schematic structural diagram of an example communication system.

Referring to FIG. 1, as an illustrative example without limitation, a simplified schematic illustration of a communication system is provided. A communication system 100 includes a radio access network 120. The radio access network 120 may be a next generation (e.g., 6G or later) radio access network, or a legacy (e.g., 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

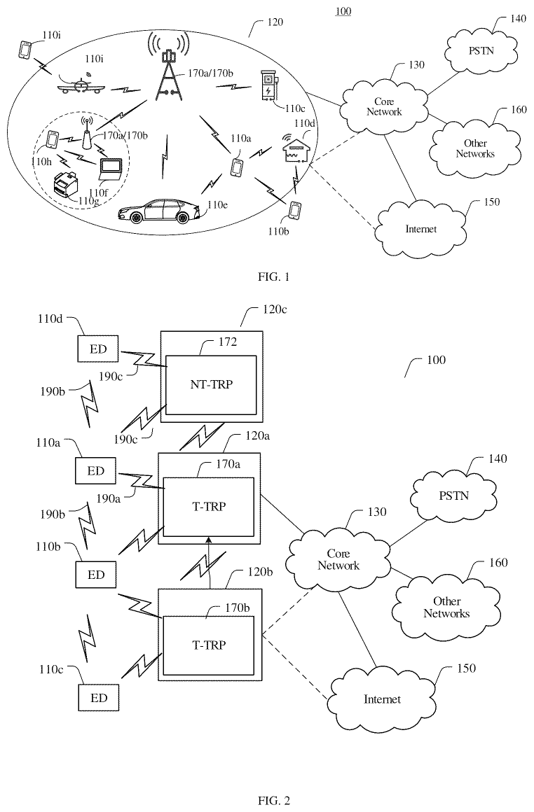

FIG. 2 is a schematic structural diagram of another example communication system.

In general, a communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet protocol (IP), transmission control protocol (TCP), and user datagram protocol (UDP). EDs 110a 110b, and 110c may be multimode devices capable of operation according to multiple radio access technologies, and incorporate multiple transceivers necessary to support such.

The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a personal communications service (PCS) phone, a session initiation protocol phone, a wireless local loop (WLL) station, a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation EDs 110 may be referred to using other terms. The base station 170a and 170b is a T-TRP and will hereafter be referred to as T-TRP 170. A NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one or more of: connection availability and connection necessity.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay nodes, donor nodes, or the like, or combinations thereof. The T-TRP 170 may refer to the foregoing devices or apparatus (e.g., communication module, modem, or chip) in the foregoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The NT-TRP 172 may be known by other names in some implementations, such as a non-terrestrial node, a non-terrestrial network device, or a non-terrestrial base station.

Artificial intelligence (AI) technologies can be applied in communication, including artificial intelligence or machine learning (AI/ML) based communication in the physical layer and/or AI/ML based communication in the higher layer, such as medium access control (MAC) layer. For example, in the physical layer, the AI/ML based communication may aim to optimize component design and/or improve the algorithm performance. For example, AI/ML may be applied in relation to the implementation of channel coding, channel modelling, channel estimation, channel decoding, modulation, demodulation, multiple-input multiple-output (MIMO), waveform, multiple access, physical layer element parameter optimization and update, beam forming, tracking, sensing, and/or positioning, etc. For the MAC layer, the AI/ML based communication may aim to utilize the AI/ML capability for learning, prediction, and/or making decisions to solve a complicated optimization problem with possible better strategy and/or optimal solution, e.g. to optimize the functionality in the MAC layer. For example, AI/ML may be applied to implement: intelligent transmission and reception point (TRP) management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

In order to facilitate understanding of the embodiments of the present application, terms related to AI/ML that may be involved in the embodiments of the present application are described below.

### (1) Data Collection

Data is a very important component for AI/ML techniques. Data collection is a process of collecting data by the network nodes, management entity, or UE for the purpose of AI/ML model training, data analytics, and inference.

### (2) AI/ML Model Training

AI/ML model training is a process to train an AI/ML Model by learning the input/output relationship in a data driven manner and obtaining the trained AI/ML Model for inference.

### (3) AI/ML Model Inference

A process of using a trained AI/ML model to produce a set of outputs based on a set of inputs.

### (4) AI/ML Model Validation

As a sub-process of training, validation is used to evaluate the quality of an AI/ML model using a dataset different from the one used for model training. Validation can help select model parameters that generalize beyond the dataset used for model training. The model parameter after training can be adjusted further by the validation process.

### (5) AI/ML Model Testing

Similar to validation, testing is also a sub-process of training, and it is used to evaluate the performance of a final AI/ML model using a dataset different from the one used for model training and validation. Different from AI/ML model validation, testing does not assume subsequent tuning of the model.

### (6) Online Training

Online training means an AI/ML training process where the model being used for inference is typically continuously trained in (near) real-time with the arrival of new training samples.

### (7) Offline Training

Offline training is an AI/ML training process where the model is trained based on the collected dataset, and where the trained model is later used or delivered for inference.

### (8) AI/ML Model Delivery/Transfer

AI/ML model delivery/transfer is a generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### (9) Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for the sustainable operation of AI/ML in the NR air-interface.

Life cycle management covers the whole procedure of AI/ML technologies applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring can be based on inference accuracy, including metrics related to intermediate key performance indicators (KPIs), and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to environmental changes, and thus the model based on input or output data distribution should also be considered.

### (10) Supervised Learning

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

### (11) Federated Learning (FL)

Federated learning is a machine learning technique that is used to train an AI/ML model by a central node (e.g., server) and a plurality of decentralized edge nodes (e.g., UEs, next Generation NodeBs, “gNBs”). The central node can also be called the central device. The edge nodes can also be called worker or worker devices. The central device is connected to the worker devices.

According to the wireless FL technique, a central node may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the central node, a set of AI/ML model parameters that describe the local AI/ML model.

Upon receiving, from a plurality of edge nodes, a plurality of sets of AI/ML model parameters that describe respective local AI/ML models at the plurality of edge nodes, the central node may aggregate the local AI/ML model parameters reported from the plurality of edge nodes and, based on such aggregation, update the global AI/ML model. A subsequent iteration progresses much like the first iteration. The central node may transmit the aggregated global model to a plurality of edge nodes. The above procedure is performed multiple iterations until the global AI/ML model is considered to be finalized, for example, the AI/ML model is converged or the training stopping conditions are satisfied.

The wireless FL technique does not involve the exchange of local data samples. Indeed, the local data samples remain at respective edge nodes.

AI-based algorithms have been introduced into wireless communications to solve a number of wireless problems such as channel estimation, scheduling, CSI compression (from UE to BS), beamforming for MIMO, localization, and so on. AI algorithms are a data-driven approach to tuning some predefined architectures by a set of data samples called training data sets.

Neural networks are a typical way to implement AI algorithms. Deep neural network (DNN) is taken as an example, the DNN can be trained with the training data sets to obtain a model for inference. Recent AI trains DNN architectures by setting up neurons with stochastic gradient descent (SGD) algorithms. For example, DNN includes CNN, RNN, transformers, and the like.

A communication system includes a plurality of connected devices. For example, a device may be a BS or UE. For example, the communication system may be the communication system 100 in FIG. 1 or FIG. 2, and the devices can be the network elements shown in FIG. 1 or FIG. 2.

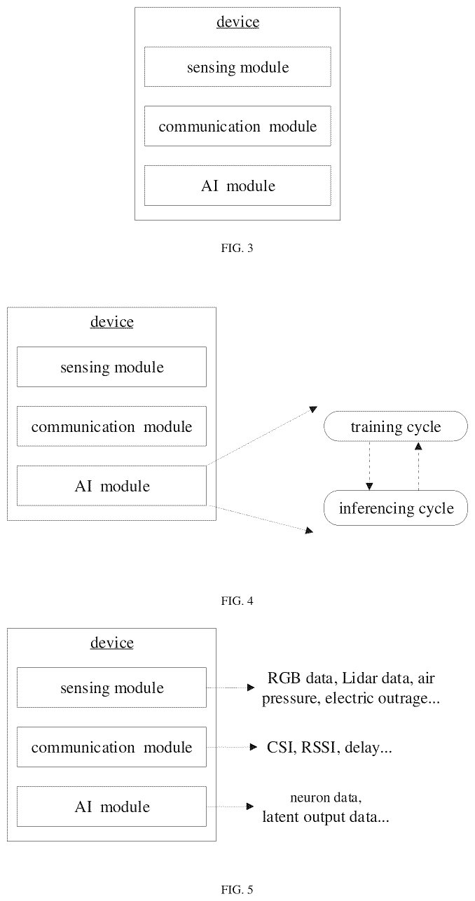

FIG. 3 is a schematic structural diagram of a device according to an embodiment of the present application. As shown in FIG. 3, the device may include at least one of sensing module, communication module, or AI module. The sensing module may be configured to sense and collect signals and/or data. The communication module may be configured to transmit and receive signals and/or data. The AI module may be configured to train and/or reason the AI implementations.

In order to facilitate understanding of the embodiment of the present application, DNN is taken as an example to illustrate an AI implementation in an embodiment of the present application.

An exemplary AI implementation is DNN-based in two cycles: a training cycle and an inference cycle. The training cycle may also be called the learning cycle. The inference cycle may also be called the reasoning circle.

FIG. 4 is a schematic diagram of a device in two cycles according to an embodiment of the present application.

As an example, during an inference cycle, the AI module of the device may perform one inference or a series of inferences with one or more DNNs to fulfill one or more tasks, where the sensing module of the device may generate signals and/or data and the communication module of the device may receive the signals and/or data from other device. For example, the inputs of the one or more DNNs may be the signals and/or data generated by the sensing module of the device, and/or the signals and/or data received by the communication module of the device. After the AI module of the device finishes inferencing, the communication module of the device may transmit the inferencing results to other device or devices.

As another example, during a training cycle, the AI module of the device may train one or more DNNs, where the sensing module of the device may generate signals and/or data and the communication module of the device may receive the signals and/or data from other device. For example, the training data of the one or more DNNs may be the signals and/or data generated by the sensing module of the device, and/or the signals and/or data received by the communication module of the device. During and/or after the AI module finishes training, the communication module of the device may transmit the training results to other device or devices.

The AI implementations may either switch between the two cycles or stay in the two cycles simultaneously.

For example, the AI module of the device may train a DNN during the training cycle. And at the end of the training cycle, the AI implementation switches to the inference cycle, which means the AI module performs inference on that trained DNN. At the end of the inference cycle the AI implementation switches to the training cycle again, and so on.

For another example, the AI module of the device may train a second DNN but still perform inference on a first DNN.

The device mentioned above is merely an example, and the way in which the modules are divided and the number of modules in FIG. 3 and FIG. 4 do not constitute any limitation to the embodiments of the present application. For example, a communication module may be replaced by two modules, i.e., a transmitting module and a receiving module. The transmitting module may be configured to transmit signals and/or data, and the receiving module may be configured to receive signals and/or data. For another example, the sensing module and the communication module may be integrated as one module. For another example, the device may also include a processing module. The processing module may be configured to process signals and/or data. For another example, the device may not include the AI module. For another example, the AI module may only be configured to reason the AI implementation, or the AI module only stays in the inference cycle.

Wireless systems may support AI in both learning and inferencing cycles for generalization and interconnections.

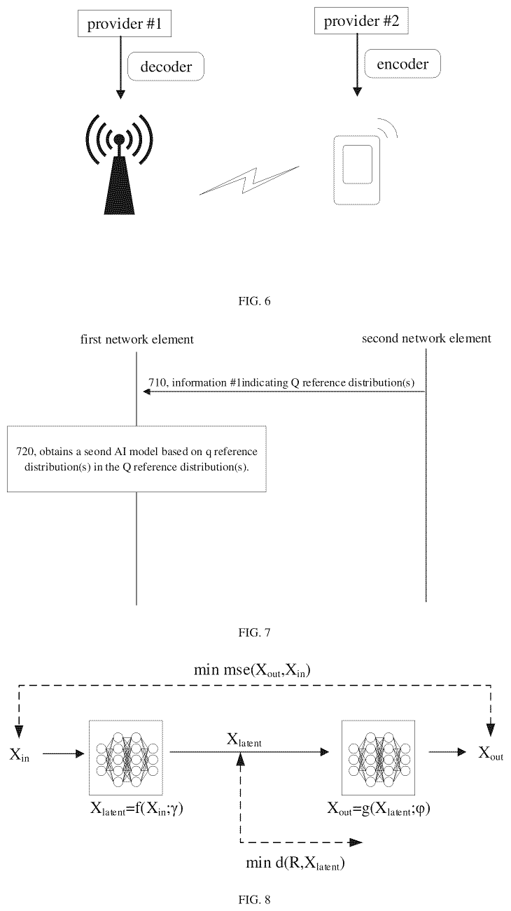

FIG. 5 shows example local data of a device. The local data of a device may include at least one of the following: local sensing data provided by the sensing module of the device, local channel data provided by the communication module of the device, local AI model data provided by the AI module of the device, or local latent output data provided by the AI module of the device. The local channel data is based on the measurement results of the channel. The local channel data can also be considered as sensing results. Thus, the local channel data can be considered as provided by the communication modules or sensing module.

For example, as shown in FIG. 5, the local sensing data may include at least one of RGB data, Lidar data, temperature, air pressure, or electric outage.

For example, as shown in FIG. 5, the local channel data may include at least one of channel state information (CSI), received signal strength indication (RSSI), or delay.

The local AI model data can also be referred to as neuron data. For example, as shown in FIG. 5, the local AI model data may include at least one of the following: part or all of the neurons in the local AI model(s) deployed on the device or part or all of gradients of the local AI model(s) deployed on the device. Neurons can be considered as functions including weights.

For example, as shown in FIG. 5, the local latent output data may include one or more latent outputs of the local AI model(s) deployed on the device.

A device may receive the local data of one or more other devices. As an example, the data received by the communication module of the device may include at least one of sensing data of one or more other devices, channel data of one or more other devices, AI model data of one or more other devices, or latent output data of one or more other devices.

For example, the data received by the communication module of device #A may include channel data of device #B and device #C, and AI model data of device #C. The channel data of device #B and device #C refer to the local channel data of device #B and the local channel data of device #C. The AI model data of device #C refers to the local AI model data of device #C. Device #A, device #B, and device #C are different devices.

For example, sensing data received by the communication module may include at least one of RGB data, Lidar data, temperature, air pressure, or electric outage.

For example, channel data received by the communication module may include at least one of CSI, RSSI, or delay.

For example, AI model data received by the communication module may include at least one of part or all of the neurons in the AI model(s), or part or all of gradients of the AI model(s).

For example, latent output data received by the communication module may include one or more latent outputs of the AI model(s).

During the training cycle, the AI module of a device may work in a single user mode or cooperative mode.

In the single user mode, the AI module of a device may train the one or more local AI models with the local data of the device.

In the cooperative mode, the AI module of a device may train the one or more local AI models with the data received from the communication module of the device.

For example, the data received from the communication module of the device may be used by the AI module to train the local AI model(s) in the following ways.

Alternative #1: the sensing data received by the communication module of the device may be accumulated into one training data set for training the local AI model(s).

Alternative #2: the channel data received by the communication module of the device may be accumulated into one training data set for training the local AI model(s).

Alternative #3: part or all of the neurons in the local AI model(s) may be set based on the AI model data received by the communication module of the device. For example, in a federated learning mode, neurons of an AI model on one device may be set based on the neurons or gradients of the AI model(s) on other device(s). Or, the gradients that the communication module of the device received may be used to update the neurons in the local AI model(s).

Alternative #4: the latent outputs received by the communication module of the device may be inputted to its local AI model(s). For example, when device #A and device #B work together to train a DNN, the device #A trains the first part of the DNN and the device #B trains the second part of the DNN. The device #A's communication module transmits the latent output of the first part of the DNN to the device #B. The device #B receives the latent output of the first part and inputs the latent output to the second part of the DNN.

In addition, the local data of a device and the data received by the communication module of the device can be used together to train the local AI model(s).

For example, the local data of a device and the data received by the communication module of the device can be used by the AI module to train the local AI model(s) in the following ways.

Alternative #1: the local sensing data provided by the sensing module of the device and the sensing data received by the communication module of the device may be mixed into one training data set for training the local AI model(s).

Alternative #2: the local channel data provided by the sensing module of the device and the channel data received by the communication module of the device may be mixed into one training data set for training the local AI model(s).

Alternative #3: part or all of the neurons in the local AI model(s) possessed by the AI module of the device and the corresponding neurons received by the communication module of the device may be averaged as the neurons in the updated local AI model(s). Or, part or all of the gradients of the local AI model(s) possessed by the AI module of the device and the corresponding gradients received by the communication module of the device may be used to update the neurons in the local AI model(s).

Alternative #4: the local latent outputs possessed by the AI module of the device and the latent outputs received by the communication module of the device may be averaged and inputted to its DNN(s).

The training performance of an AI model is crucial for its application. For example, in some scenarios, a plurality of AI models deployed on different devices may need to work together. However, the AI models may be trained independently by different providers, making it difficult to ensure the training quality, which may result in the AI models not working together.

FIG. 6 is a schematic diagram of an example scenario.

As shown in FIG. 6, an encoder deployed on UE and a decoder deployed on BS need to work together. However, the encoder and the decoder may be trained independently by different providers, e.g., provider #1 and provider #2 in FIG. 6, which may affect their interconnection.

The embodiment of the present application provides a communication method, where the difference between reference distribution and local data can be applied to improve the training performance.

FIG. 7 is a schematic flow chart of a communication method provided by the embodiments of the present application.

As shown in FIG. 7, a method 700 includes the following steps.

710, a first network element receives information #1 (an example of the first information) indicating Q reference distribution(s) from a second network element. Q is a positive integer.

The Q reference distribution(s) may correspond to Q layer(s) of one or more AI models, respectively. One reference distribution corresponds to one layer, which may be understood as the reference distribution corresponds to the output of the layer.

The Q reference distribution(s) may also be called reference distribution(s) of the Q layer(s).

For the convenience of description, in the embodiments of present application, the Q layer(s) belonging to one AI model (the first AI model) is used as an example for explanation.

720, the first network element obtains a second AI model based on q reference distribution(s) in the Q reference distribution(s). q is a positive integer. q≤Q.

For example, the first network element may be the device in FIG. 3. The communication module of the first network element may receive the information #1. The AI module of the first network element may perform the step 720.

For example, the first network element may be a terminal device or a network device.

For example, the second network element may be the device in FIG. 3. The communication module of the second network element may transmit the information #1.

For example, the second network element may be a network device or a terminal device.

In step 720, the first network element may train the first AI model to obtain the second AI model.

The first AI model and the second AI model are models with the same structure. The parameters of the first AI model and the second AI model are different. The first AI model and the second AI model can be understood as an AI model at different stages of the training process. For example, the second AI model can be considered as the first AI model that has been trained. In other words, the second AI model can be considered as the training result of the first AI model.

The structure of the two AI models is the same. For the convenience of description, the first AI model and the second AI model will be collectively referred to as the AI model in the following text. The AI model in the training cycle or the AI model to be trained in the following text can be considered as the first AI model, and the AI model obtained after training with method 700 can be considered as the second AI model.

During the training cycle, the AI module of a device may work in a single user mode or cooperative mode. In both modes, the device may train an AI model with one or more reference distributions.

One reference distribution is taken as an example to describe some example representations of the reference distribution.

In some embodiments, a reference distribution may be in a form of the parameterized standard distribution R˜ [symbol] (λ₁, λ₂, . . . ) such as normal distribution, Poisson distribution, Rayleigh distribution, and so on. R represents the reference distribution. [symbol] (λ₁, λ₂, . . . ) represents the parameterized standard distribution. λ₁ and λ₂ represent the statistic parameters used to describe the parameterized standard distribution.

In some embodiments, a reference distribution may be in a form of a combination of multiple parameterized standard distributions.

For example, a reference distribution may be in a form of a linear combination of multiple Gaussian distributions.

In some embodiments, a reference distribution may be in a form of a plurality of reference data samples, such as R: [r₁, r₂, . . . , r_{M}]. r₁ is the first reference sample used to represent the reference distribution, r₂ is the second reference sample used to represent the reference distribution, and so on. M is the number of the reference data samples used to represent the reference distribution.

The reference data sample can be the original dimension of the reference data or the compressed dimension of the reference data. In other words, the reference data sample can be a raw data sample or a compressed data sample. The original dimension can be the dimension of the output data of the layer corresponding to the reference distribution.

In one possible implementation, a compressed data sample can be obtained by compressing a raw data sample according to a first transformation matrix. The first transformation matrix can be a unitary matrix or an orthonormal matrix.

In some embodiments, each basis vector of the first transformation matrix may be a standard basis such as Fourier basis, DCT basis, wavelet basis, or the like.

In some embodiments, basis vectors of the first transformation matrix may be built as needed. As an example, basis vectors of the first transformation matrix may be built on the reference distribution.

For example, one raw data sample x may be denoted as an n×1 sample, where n is an integer greater than 1. The first transformation matrix U may be denoted as an n×r matrix, where r is a positive integer smaller than n. Matrix U may be a unitary matrix, in which case U^{H}U=I and c=U^{H}x. c is the compressed data sample. The reference data sample can be x or c.

In one possible implementation, a compressed data sample can be obtained by compressing the sampling result of a raw data sample according to a second transformation matrix. The sampling result of the raw data sample is obtained by sampling some values of the raw data sample with a sampling matrix.

Optionally, a sampling matrix may be a random matrix or a pseudo-random matrix. A first transformation matrix may be sampled to a compact matrix which is smaller than the first transformation matrix through a sampling matrix.

For example, the sampling matrix P may be as follows:

$$P = [ \begin{matrix}0 & ⋯ & 1 & ⋯ & 0 & ⋯ & 0 & ⋯ & 0 \\ 0 & ⋯ & 0 & ⋯ & 1 & ⋯ & 0 & ⋯ & 0 \\ \\ & \\ & \\ & \\ & ⋯ & \\ & \\ & \\ & \\ \\ 0 & ⋯ & 0 & ⋯ & 0 & ⋯ & 1 & ⋯ & 0\end{matrix} ] .$$

The number of rows in the sampling matrix is the number of positions sampled in the raw data sample.

For example, a sampling matrix P corresponding to a raw data sample x may be applied to a first transformation matrix U. P may be denoted as an m×n matrix, where men, and m is a positive integer. Further, m<<n. P may be used to “compress” U into a second transformation matrix θ, which is an m×r matrix. θ=PU. The compressed data sample can be obtained by c=θ⁺x′. x′ is an m×1 sample composed of the values sampled from x through the sampling matrix P. θ⁺ is the left inverse of the second transformation matrix.

The above are only some examples. The compressed data sample can also be obtained through other compression ways. The embodiments of the present application are not limited to these.

The reference distribution represented by one or more standard distributions saves much more radio resources than the reference distribution represented by a plurality of reference data samples.

In the case of Q>1, the representation of the Q reference distributions can be the same or different.

For example, the second network element may send the information #1 in broadcast, multicast, or unicast way.

The following describes some examples of the information #1.

For example, the information #1 may indicate the statistic parameters of the Q reference distribution(s).

As mentioned before, a reference distribution may be a parameterized standard distribution or a combination of multiple parameterized standard distributions. The information #1 may indicate the description of the reference distribution by some statistic parameters.

For another example, the information #1 may indicate the reference data samples used to represent the Q reference distribution(s).

For another example, the information #1 may indicate the index(s) of the Q reference distribution(s).

Exemplarily, there may be multiple candidate reference distribution(s) in the first network element. The information #1 may include the index of the Q reference distribution(s) within the multiple candidates.

The information #1 can also be in other forms, as long as it can indicate Q reference distribution(s).

The step 710 is an optional step. The first network element can determine the Q reference distribution(s) in other ways. For example, the Q reference distribution(s) may be predefined. For another example, the Q reference distribution(s) may be determined by the first network element itself.

The Q layer(s) may include at least one latent layer of the one or more AI models.

For example, the Q layer(s) includes one or more latent layers of the first AI model.

Further, the Q layer(s) may also include one or more input layers and/or output layers of the one or more AI models.

In some embodiments, the Q layer(s) may be determined by the second network element.

Method 700 may also include: the second network element may send information #2 (an example of the third information) indicating the Q layer(s) to the first network element.

The information #2 is used to indicate which layer each reference distribution in the Q reference distribution(s) corresponds to.

Take Q=2 as an example. The Q reference distribution(s) may include reference distribution #1 and reference distribution #2. The information #2 is used to indicate which layer the reference distribution #1 corresponds to and which layer the reference distribution #2 corresponds to.

For example, the information #2 may include the Q indicator(s) indicating the Q layer(s) respectively.

As an example, the Q indicator(s) may be the index(s) of the Q layer(s).

The information #2 can also be in other forms, as long as it can indicate which reference distribution corresponds to which layer.

In some embodiments, the Q layer(s) may be determined by the first network element. Before the step 710, the first network element may send information #3 indicating the Q layer(s) to the second network element. The second network element may determine the Q reference distribution(s) according to the information #3.

The form of information #3 may refer to the information #2 and will not be repeated here.

In some embodiments, the correspondence between Q layer(s) and the Q reference distribution(s) may be predefined.

In some embodiments, the first network element may choose q reference distribution(s) from the Q reference distribution(s) to train the AI model.

The q layer(s) corresponding to the q reference distribution(s) may include at least one latent layer of the AI model (the first AI model).

Optionally, the q layer(s) corresponding to the q reference distribution(s) may be q latent layer(s) of the AI model (the first AI model).

Further, the q layer(s) may also include the output layer of the AI model (the first AI model).

Step 720 may include: the first network element trains an AI model (the first AI model) based on the distance(s) between the q reference distribution(s) and the distribution(s) of corresponding q layer(s) of the AI model.

In the embodiment of the present application, the distance between the two can also be understood as the difference between the two. For example, the distance(s) between the q reference distribution(s) and the distribution(s) of corresponding q layer(s) can also be understood as the difference(s) between the q reference distribution(s) and the distribution(s) of corresponding q layer(s).

The training data set can refer to the previous text such as the relevant content with FIG. 5 and will not be repeated here.

The q reference distribution(s) may correspond to the q layer(s), respectively. The q layer(s) belongs to the Q layer(s). The distance between the reference distribution of each layer in the q layer(s) and the distribution of the layer may be measured.

A distribution of a layer refers to the distribution of its outputs.

The distance between the reference distribution of one layer and the distribution of the layer can also be considered as the distance between the reference distribution of the layer and the layer output during the training cycle.

For example, the q reference distribution(s) may include reference distribution #1 and reference distribution #2. The reference distribution #1 may correspond to the output of layer #1, and the reference distribution #2 may correspond to the output of layer #2.

The distance between the reference distribution of each layer in the q layer(s) and the distribution of the layer may be measured with a scoring function.

The scoring function is mathematically differentiable.

For example, the scoring function may be based on one of the following: Kullback-Leibler divergence (KL divergence), graph edit distance, Wasserstein distance, or Jensen-Shannon distance (JSD distance).

In the case of q>1, for different reference distributions, the scoring functions may be the same or different.

Take q=2 as an example. The q reference distribution(s) may include reference distribution #1 R₁ and reference distribution #2 R₂. Scoring function #1 d₁(R₁, \hat{R}₁) is used to measure the distance with the reference distribution #1 R₁. \hat{R}₁ may represent the latent layer output corresponding to the reference distribution #1 R₁. Scoring function #2 d₂(R₂, \hat{R}₂) is used to measure the distance with the reference distribution #2 R₂. \hat{R}₂ may represent the latent layer output corresponding to the reference distribution #2 R₂. d₁( ) and d₂( ) may be the same or different.

In some embodiments, the q scoring function(s) used to measure distance(s) between the q reference distribution(s) and the distribution of the q layer(s) respectively may be determined by the second network element.

Method 700 may also include: the first network element may receive information #4 (an example of the fourth information) indicating Q scoring function(s) used to measure distance(s) between the Q reference distribution(s) and the distribution of the Q layer(s) respectively from the second network element.

Q=2 is taken as an example. The Q reference distribution(s) may include reference distribution #1 and reference distribution #2. The information #4 is used to indicate the scoring function #1 used to measure the distance with the reference distribution #1 and the scoring function #2 used to measure the distance with the reference distribution #2.

For example, the information #4 may include the Q scoring function(s).

For another example, the information #4 may include the index of the Q scoring function(s).

In some embodiments, the q scoring function(s) may be determined by the first network element.

The first network element may get the q scoring function(s) through other methods. For example, the correspondence between the Q scoring function(s) and the Q layer(s) may be predefined. The first network element may get the q scoring function(s) according to the q layer(s).

At step 720, the first network element may set up one or more regularizations with the q reference distribution(s). The one or more regularizations are used to minimize the distance(s) between the q reference distribution(s) and the distribution(s) of corresponding q layer(s).

The first network element may set up q regularization(s) on distribution(s) of the q layer(s) based on the q reference distribution(s), respectively.

The first network element may obtain the second AI model with one or more regularizations used to minimize difference(s) between the q reference distribution(s) and distribution(s) of corresponding q layer(s) in the first AI model.

In other words, the first network element may train the AI model based on an objective function including one or more regularizations used to minimize the distance(s) between the q reference distribution(s) and the distribution(s) of corresponding q layer(s).

During the training cycle, the first network element may minimize the scoring function(s) as a training optimal regularization or regularizations. The one or more regularizations can be considered as additional constraints in the learning process.

In this way, the first network element can shape the q layer output(s) by the q reference distribution(s). Further, the q layer output(s) may include at least one latent layer output, in which case, the at least one latent layer output can be shaped based on the reference distribution(s).

The reference distribution(s) can be set as needed to obtain the required AI model, which is beneficial to improving the training performance of the AI model.

The above technical solutions can be conducive to achieving the interconnection of multiple AI models.

The q reference distribution(s) may be consistent with the output of the q layer(s) in the other AI model which needs to work with the second AI model. According to the above technical solution, the distribution of q layer(s) in the second AI model can be as close as possible to the distribution of q layer(s) in the other AI model, which is conducive to achieving interconnection between the two AI models.

In some scenarios, multiple AI models may need to work together, where output of a latent layer of one model (e.g., model #A) may be input of another model (e.g., model #B) or input of a latent layer in another model. According to the technical solutions of the present application embodiments, training the model #A based on the reference distribution, is beneficial to making the distribution of the latent layer output of the model #A as close as possible to the reference distribution. The reference distribution can be consistent with the input of model #B, in which case, the distribution of the latent layer output of model #A is as close as possible to the distribution of the input of model #B, which is conducive to achieving interconnection between model #A and model #B. Relevant examples can refer to the Example scenario-2 in the following text.

The above technical solutions can be beneficial to improving the training performance of an AI model.

According to the embodiments of the present application, one or more regularizations are added in the middle part of an AI model, which is equivalent to introducing an additional loss. The one or more regularizations on the latent layer output(s) are conducive to more sufficient training for the latent layer(s), improving the transparency and directness of the learning process for the latent layer(s), and improving convergence efficiency.

FIG. 8 is a schematic diagram of an example regularization on the distribution of one latent layer output.

As shown in FIG. 8, the first network element trains a DNN-based autoencoder (AE) with a training data set. The AE includes an encoder f( ) and a decoder g( ) The input to the AE is the input to the encoder. The output of the encoder is the input to the decoder. The output from the AE is the output from the decoder. The relationship between the input and output of the encoder can be represented as Xₗₐₜₑₙₜ=f(Xᵢₙ; γ). γ represents parameters of the encoder. The relationship between the input and output of the decoder can be represented as Xₒᵤₜ=g(Xₗₐₜₑₙₜ; φ). φ represents parameters of the decoder. The training goal of AE is to minimize the difference between input Xᵢₙ and output Xₒᵤₜ. For example, the loss function may be based on the mean square error (MSE). The training goal of AE is to minimize the loss function such as min mse(Xᵢₙ, Xₒᵤₜ).

The output of the encoder can be considered as a latent layer output of the AE. The regularization on the distribution of the latent layer output is used to minimize the scoring function such as min d(R, Xₗₐₜₑₙₜ). The regularization can be considered as an additional constraint in the learning process. d( ) represents the scoring function used to measure the difference between the reference distribution R and the latent layer output Xₗₐₜₑₙₜ.

The above is only an example scenario and does not constitute a limitation on the technical solutions of the present application embodiment. For example, the AI model can also be other models. For another example, q can also be other values.

q=2 is taken as an example. The first network element may set up regularization #1 that minimizes the distance between the reference distribution #1 R₁ and the corresponding latent layer output #1 \hat{R}₁:

$${ϕ}^{*} = {arg min}_{ϕ} {d}_{1} ( {R}_{1} , {\hat{R}}_{1} ) ,$$

in which case \hat{R}₁=F₁(X; φ). F₁( ) represents the mapping relationship between the input of the AI model X and the corresponding latent layer output #1 \hat{R}₁. φ represents the parameters of the AI model. φ* represents the parameters of the AI model after updating the parameters. The first network element may set up regularization #2 that minimizes the distance between the reference distribution #2 and the corresponding latent layer output #2:

$${ϕ}^{*} = {arg min}_{ϕ} {d}_{2} ( {R}_{2} , {\hat{R}}_{2} ) ,$$

in which case \hat{R}₂=F₂(X; φ). F₂( ) represents the mapping relationship between the input of the AI model and the corresponding latent layer output #2. The two regularizations above can be considered as additional constraints in the learning process.

If a reference distribution is in the form of a plurality of reference data samples, the first network element may input them into the corresponding regularization.

Optionally, the reference data samples may be disordered by the first network element before being input into the regularization.

In this way, data augmentation can be achieved, which is beneficial to improving the training performance of the AI model.

Two regularizations mentioned above are taken as examples. If the reference distribution #1 is in the form of a plurality of reference data samples, the first network element may disorder the reference data samples and input them into the regularization #1. If the reference distribution #2 is in the form of a plurality of reference data samples, the first network element may disorder the reference data samples and input them into the regularization #2.

In the case where a reference distribution is in the form of a plurality of reference data samples, when the reference data samples are compressed data samples, the distance between the reference distribution and the distribution of the corresponding layer may be the distance of the original dimension or the distance of the compressed dimension.

Optionally, when the reference data samples are compressed data samples, the distance between the reference distribution and the distribution of the corresponding layer may be based on the reference data samples and the compression result of the outputs of the corresponding layer, in which case, the distance between the reference distribution and the distribution of the corresponding layer is the distance of the compressed dimension.

For example, when the reference data samples are compressed data samples, the first network element may disorder the reference data samples and input them into the corresponding regularization. The first network element may compress the outputs of the corresponding layer, and input them into the corresponding regularization.

The compression method can refer to the previous text and will not be repeated here.

Optionally, when the reference data samples are compressed data samples, the distance between the reference distribution and the distribution of the corresponding layer may be based on the decompression result of reference data samples and the outputs of the corresponding layer, in which case, the distance between the reference distribution and the distribution of the corresponding layer is the distance of the original dimension.

For example, when the reference data samples are compressed data samples, the first network element may decompress the reference data samples, disorder the decompression result, and input them into the corresponding regularization. The first network element may input the outputs of the corresponding layer into the corresponding regularization.

The decompression method can refer to the previous compression method, which involves performing inverse operations on the compression process, and will not be repeated here.

If a reference distribution is in the form of parameterized standard distribution, the first network element may generate a plurality of reference data samples according to the parameterized standard distribution and input them into the corresponding regularization.

For example, the first network element may generate a plurality of reference data samples by the randomly parameterized standard distribution.

Two regularizations mentioned above are taken as examples. If the reference distribution #1 is in the form of parameterized standard distribution, the first network element may generate a plurality of reference data samples by randomly the parameterized standard distribution and input them into the regularization #1. If the reference distribution #2 is in the form of parameterized standard distribution, the first network element may generate a plurality of reference data samples by randomly the parameterized standard distribution and input them into the regularization #2.

In the case of q>1, the forms of the q reference distributions can be the same or different.

The first network element may measure the resultant score(s) of the q regulation(s). The resultant score(s) of the q regulation(s) is related to the result(s) of the distance(s) between the q reference distribution(s) and the corresponding layer output(s) of the current AI model.

There is a positive correlation between the resultant score(s) of the q regulation(s) and the distance(s) between the q reference distribution(s) and the corresponding layer output(s) of the current AI model.

For example, the resultant score(s) of the q regulation(s) can be the distance(s) between the q reference distribution(s) and the corresponding layer output(s) of the current AI model.

The above positive correlation is only an example, and there can also be other relationships between the two, such as negative correlation. The technical solutions in the present application embodiments only take the positive correlation relationship as an example for explanation. When there is another relationship between the two, the corresponding description can be adjusted appropriately.

For example, at each epoch, the first network element may measure the minimum score(s) that it can achieve by optimizing the regulation(s).

At each epoch, the minimum score(s) may be the resultant score(s) of the q regulation(s) measured after the end of an epoch.

In other words, after the end of an epoch, the first network element may measure the resultant score(s) of the q regulation(s).

For another example, the first network element may measure the resultant score(s) of the q regulation(s) after the training is completed.

Two regularizations mentioned above are taken as examples. The resultant scores of the regularization #1 is d₁(R₁, \hat{R}₁), in which case \hat{R}₁=F₁(X; φ*). The resultant scores of the regularization #2 is d₂(R₂, \hat{R}₂), in which case \hat{R}₂=F₂(X; φ*).

Optionally, the first network element may memorize the resultant score(s) of the q regulation(s).

Further, optionally, the method 700 may also include step 730.

730, the first network element sends information #5 (an example of the second information) indicating optimization result(s) of the one or more regularizations to one or more other devices, such as the second network element.

For example, the optimization result(s) of the one or more regularizations may be the resultant score(s) of the q regularization(s).

Exemplarily, step 730 may be performed by the communication module of the first network element.

The first network element may send the resultant score(s) in broadcast, multicast, or unicast way.

The information #5 can be represented in various forms.

For example, the information #5 may include the resultant score(s) of the q regularization(s). In other words, the first network element transmits the resultant score(s) of the q regularization(s).

For another example, there may be multiple ranges. Each range corresponds to a level. The information #5 may indicate q level(s) corresponding to the range(s) to which the q resultant score(s) belong.

The following describes an example explanation of the timing of sending the information #5.

In some embodiments, the first network element may send the information #5 once the resultant score(s) of the q regulation(s) has been measured.

For example, after the end of an epoch, the first network element may send the information #5.

For another example, after the end of a batch, the first network element may send the information #5.

For another example, after the training is finished, the first network element may send the information #5.

In some embodiments, the first network element may send the information #5 in response to the request sent by the other network element(s) such as the second network element for the resultant score(s).

In some embodiments, the first network element may send the information #5 if the resultant score(s) is less than or equal to one or more thresholds.

If the resultant score(s) is less than or equal to one or more thresholds, the AI model may meet the requirements. For example, the second network may consider the AI model on the first network element as candidates that meet usage conditions.

For example, if the resultant score(s) are consistently below the corresponding threshold(s), the AI model may meet the requirements. In the case of q>1, the q thresholds can be the same or different. The threshold(s) may be pre-defined. Or the threshold(s) may be received by the device. Or the threshold(s) may be determined by the device itself.

The interconnection of AE on two devices is taken as an example. The output of the encoder on device #1 is the input of the decoder on device #2. The distribution of the input of the decoder on device #2 can be used as a reference distribution. If the distance between the output of the encoder on device #1 and the reference distribution is less than or equal to the threshold after training, the AE on device #1 can be used as a candidate for interconnection with the AE on device #2.

In some embodiments, the first network element may send the information #5 if the resultant score(s) is greater than or equal to one or more thresholds.

The following describes an exemplary explanation of method 700 of the embodiments in the present application based on two examples (Example scenario-1 and Example scenario-2).

### Example Scenario-1

Optionally, method 700 may be applied in federated learning.

There is a communication system including one central device and a plurality of worker devices. For example, the worker device may include the modules shown in FIG. 3, where the sensing module may be used to collect the local data, the AI module may be used to train its local AI model such as a DNN, and the communication module may be used to receive signals and/or data from the central device and transmit signals and/or data to the central device. The central device may at least include a communication module and an AI module shown in FIG. 3.

For example, the central device can be the second network element in method 700, and the worker device can be the first network element in method 700.

The following describes an example of a possible implementation of federated learning.

The central device and the worker devices may work together epoch by epoch in a federated learning way. Specifically, the communication module of a worker device transmits all of its local neurons or a portion of its local neurons to the central device. The communication module of the central device receives these neurons from a plurality of the worker devices, the AI module of the central device aggregates these neurons and updates the AI model based on this, and then the communication module transmits the updated neurons to in a broadcast or multicast way to the worker devices. For example, the AI module of the central device averages these neurons, and then the communication module of the central device transmits the averaged neurons to the worker devices. The communication module of a worker device receives the updated neurons, and the AI module of the worker device sets the updated neurons into its local DNN. Then the AI module of the worker device trains the updated local DNN. Repeat the above process epoch by epoch, batch by batch, until the central device and the worker devices finish training the DNN. The DNN trained on all the involved worker devices in the federated learning must have the identical architecture.

On top of the traditional federated learning above, the following illustrates an example of the application of the technical solution of the present application to federated learning.

The communication module of the central device may send information #1 indicating Q reference distribution(s), e.g., Q=2 to the worker devices in broadcast, multicast, or unicast way.

In addition, the central device may also indicate one or more of the following: the scoring functions corresponding to the two reference distributions, and the layers of the AI model corresponding to the two reference distributions.

For example, the communication module of the central device may send the messages to the worker devices in broadcast, multicast, or unicast way to inform the worker devices of on which layers to regularize the training score with which scoring function to which reference distribution.

The above process corresponds to step 710, and the specific description can refer to step 710, which will not be repeated here.

The AI module of the worker device sets up regularization(s) on its AI model undertrained with the reference distribution(s). The worker device trains its AI model at an epoch.

Further, the AI model of the worker device may memorize the resultant score(s) of the regularization(s) after the end of the epoch.

The above process corresponds to step 720, and the specific description can refer to step 720, which will not be repeated here.

Further, the communication module of the worker device may transmit the resultant score(s) of the regularization(s) to the central device.

The above process corresponds to step 730, and the specific description can refer to step 730, which will not be repeated here.

The above is only an example process of the application of the technical solutions in the present application embodiments to federated learning. The technical solutions in the present application embodiments can also be implemented in other ways when applied to federated learning, and the related description can refer to method 700, which will not be repeated here.

The resultant score(s) of the regularization(s) may reflect the training status of the AI models on the working devices. For example, the AI model with smaller resultant score(s) may have higher training quality and/or faster training speed.

Further, the central device may schedule the working devices according to the resultant score(s) of the regularization(s).

### Example Scenario-2

In some scenarios, a plurality of AI models deployed on different devices may need to work together. These AI models may be trained independently by different providers.

For example, an encoder and a decoder deployed on different devices may need to work together.

Optionally, method 700 may be applied to train autoencoders on different devices. After the training is completed, the encoder can be deployed on the transmitter side, and the decoder can be deployed on the receiver side. The transmitter side is an encoding device. The receiver side is a decoding device. The encoder of the encoding device may output to the decoder of the decoding device.

The following takes a DNN-based autoencoder as an example. The encoder can be an encoding DNN, and the decoder can be a decoding DNN.

There are two devices, device #1 and device #2 used to train AEs respectively. For example, the device #1 may include the modules shown in FIG. 3, where the sensing module may be used to collect the local data, the AI module may be used to train a DNN-based autoencoder #1 with its local data, and the communication module may be used to receive signals and/or data and transmit signals and/or data. The device #2 may include the modules shown in FIG. 3, where the sensing module may be used to collect the local data, the AI module may be used to train a DNN-based autoencoder #2 with its local data, and the communication module may be used to receive signals and/or data and transmit signals and/or data.

The device #1 can be the first network element.

Q=1 is taken as an example; the reference distribution may correspond to the output of the encoder in the AE.

The AI model of the device #1 sets up the regularization on its DNN-based autoencoder #1 undertrained with the reference distribution. The device #1 trains its DNN-based autoencoder #1 at an epoch.

Further, the AI model of the device #1 may memorize the resultant score(s) of the regularization(s) after the end of the epoch.

The above process corresponds to step 720, and the specific description can refer to step 720, which will not be repeated here.

In some implementations, the reference distribution can be the distribution of the encoder output in the DNN-based autoencoder #2 on the device #2.

For example, the device #2 may send the distribution of the encoder output in the DNN-based autoencoder #2 to the device #1 after the end of an epoch, in which case, the device #2 can be considered as the second network element.

The above process corresponds to step 710, and the specific description can refer to step 710, which will not be repeated here.

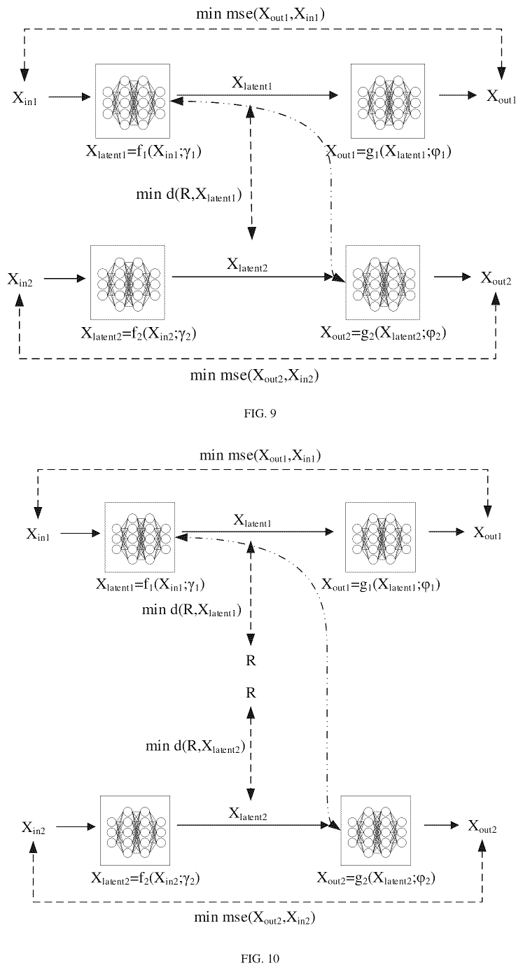

FIG. 9 shows a schematic diagram of an example training process of AE.

The AI module of the device #2 trains the autoencoder #2 with its local data. The training goal may be minimizing the difference between the input to the autoencoder #2, e.g. Xᵢₙ₂ in FIG. 9, and the output of the autoencoder #2, e.g. Xₒᵤₜ₂ in FIG. 9. The difference between Xᵢₙ₂ and Xₒᵤₜ₂ can be measured by the mean squared error between them, such as mse(Xₒᵤₜ₂,Xᵢₙ₂) in FIG. 9. f₂( ) represents the encoder of the autoencoder #2. γ₂ represents parameters of the encoder f₂( ). g₂( ) represents the decoder of the autoencoder #2, and φ₂ represents parameters of the decoder g₂( ). The output of the encoder is the input of the decoder.

For example, after the end of an epoch, the device #2 may send the distribution of the encoder output in the autoencoder #2 as a reference distribution R to the device #1. The reference distribution R can be the Xₗₐₜₑₙₜ₂, that is the output of the encoder in the autoencoder #2. The device #1 sets up the regularization on its autoencoder #1 undertrained with the reference distribution R. The reference distribution R corresponds to the latent layer output Xₗₐₜₑₙₜ₁, that is the output of the encoder. d( ) is the scoring function used to measure the distance between two distributions.

The AI module of the device #1 trains the autoencoder #1 with its local data. The training goal may be minimizing the difference between the input to the autoencoder #1, e.g. Xᵢₙ₁ in FIG. 9, and the output of the autoencoder #1, e.g. Xₒᵤₜ₁ in FIG. 9. The difference between Xᵢₙ₁ and Xₒᵤₜ can be measured by the mean squared error between them, such as mse(Xₒᵤₜ₁,Xᵢₙ₁) in FIG. 9. f₁( ) represents the encoder of the autoencoder #1. γ₁ represents parameters of the encoder f₁( ). g₁( ) represents the decoder of the autoencoder #1, and φ₁ represents parameters of the decoder g₁( ). The output of the encoder is the input of the decoder. In addition, during the training cycle, the AI module of the device #1 may also minimize the scoring function d(R, Xₗₐₜₑₙₜ₁) as a training optimal regularization.

Further, the communication module of the device #1 may transmit the resultant score of the regularization to the device #2.

For example, the communication system of the device #2 may send a message to the device #1 to ask the device #1 to measure and feedback the resultant score of the regularization.

The above process corresponds to step 730, and the specific description can refer to step 730, which will not be repeated here.

In some implementations, the reference distribution can be a common reference distribution for both DNN-based autoencoder #1 and DNN-based autoencoder #2.

In this case, the AI model of the device #1 also sets up the regularization on its DNN-based autoencoder #2 undertrained with the reference distribution. The device #2 trains its DNN-based autoencoder #2 at an epoch.

Further, the AI model of the device #2 may memorize the resultant score(s) of the regularization(s) after the end of the epoch.

The above process corresponds to step 720, and the specific description can refer to step 720, which will not be repeated here.

For example, the reference distribution may be sent from the device #2 to the device #1. Alternatively, the reference distribution may be sent from the device #3 to the device #1 and device #2.

The device that sends the reference distribution can be considered as the second network element.

The above process corresponds to step 710, and the specific description can refer to step 710, which will not be repeated here.

FIG. 10 shows a schematic diagram of an example training process of AE.

The AI module of the device #1 sets up the regularization on its autoencoder #1 undertrained with the reference distribution R. The reference distribution R corresponds to the latent layer output Xₗₐₜₑₙₜ₁, that is the output of the encoder. The AI module of the device #2 sets up the regularization on its autoencoder #2 undertrained with the reference distribution R. The reference distribution R corresponds to the latent layer output Xₗₐₜₑₙₜ₂, that is the output of the encoder.

d( ) is the scoring function used to measure the distance between two distributions.

The AI module of the device #1 trains the autoencoder #1 with its local data. The training goal may be minimizing the difference between the input to the autoencoder #1 and the output of the autoencoder #1. The difference between Xᵢₙ₁ and Xₒᵤₜ₁ can be measured by the mean squared error between them, such as mse(Xₒᵤₜ₁,Xᵢₙ₁) in FIG. 10. In addition, during the training cycle, the AI module of the device #1 may also minimize the scoring function d(R, Xₗₐₜₑₙₜ₁) as a training optimal regularization.

The AI module of the device #2 trains the autoencoder #2 with its local data. The training goal may be minimizing the difference between the input to the autoencoder #2 and the output of the autoencoder #2. The difference between Xᵢₙ₂ and Xₒᵤₜ₂ can be measured by the mean squared error between them, such as mse(Xₒᵤₜ₂,Xᵢₙ₂) in FIG. 10. In addition, during the training cycle, the AI module of the device #2 may also minimize the scoring function d(R, Xₗₐₜₑₙₜ₂) as a training optimal regularization.

According to the technical solutions of the present application embodiments, training the autoencoder #1 and autoencoder #2 based on the same reference distribution R, is beneficial to making the distribution of the latent layer output of the autoencoder #1 and autoencoder #2 as close as possible to the reference distribution. In this way, the distribution of the latent layer output of the autoencoder #1 and autoencoder #2 can be consistent with each other, which is conducive to achieving interconnection between model #A and model #B.

Further, the communication module of the device #1 may transmit the resultant score of the regularization to the device #2 and/or the device #3.

For example, the communication system of the device #2 may send a message to the device #1 to ask the device #1 to measure and feedback the resultant score of the regularization.

The above process corresponds to step 730, and the specific description can refer to step 730, which will not be repeated here.

For example, as shown in FIG. 9 or FIG. 10, the encoding DNN of the autoencoder #1 trained by the device #1 can be deployed on the encoding device, and the decoding DNN of the autoencoder #2 trained by the device #2 can be deployed on the decoding device.

Alternatively, the decoding DNN of the autoencoder #1 trained by the device #1 can be deployed on the decoding device, and the encoding DNN of the autoencoder #2 trained by the device #2 can be deployed on the encoding device.

The above is only an example process of the application of the technical solutions in the present application embodiments to AE training. The technical solutions in the present application embodiments can also be implemented in other ways when applied to AE training, and the related description can refer to method 700, which will not be repeated here.

The transmission process in example scenario-1 and example scenario-2 are merely examples. For other implementation methods, please refer to method 700.

The communication method according to the embodiments of the present application is described in detail above, and the communication apparatus according to the embodiments of the present application will be described in detail below with reference to FIGS. 11-15.

FIG. 11 is a schematic block diagram of a communication apparatus 10 according to an embodiment of the present application. As shown in FIG. 11, the communication apparatus 10 includes:
a transceiver module 11, configured to receive first information indicating Q reference distribution(s) corresponding to Q layer(s) of a first AI model, where Q is a positive integer; and
a processing module 12, configured to obtain a second AI model based on q reference distribution(s) in the Q reference distribution(s), where q is a positive integer, q≤Q.

The communication apparatus 10 in this embodiment of the present application may correspond to the first network element in the communication method in the embodiments of the present application described above, and the foregoing management operations and/or functions and other management operations and/or functions of modules of the communication apparatus 10 are intended to implement corresponding steps of the foregoing methods. For brevity, details are not described herein again.

The transceiver module 11 in this embodiment of the present application may be implemented by a transceiver. The processing module 12 in this embodiment of the present application may be implemented by a processor.

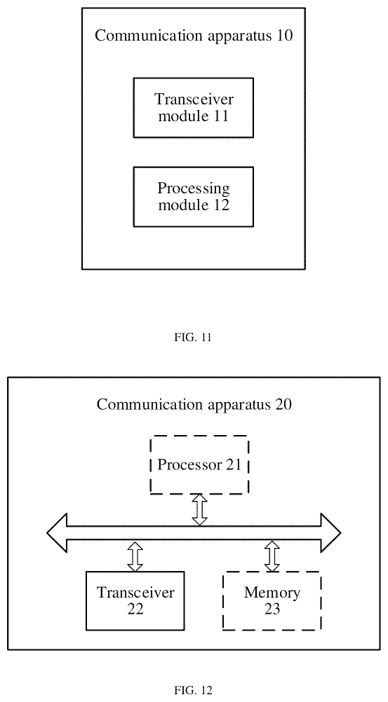

As shown in FIG. 12, a communication apparatus 20 may include a transceiver 21. Optionally, the communication apparatus 20 may further include a processor 22 and/or a memory 23. The memory 23 may be configured to store indication information, or may be configured to store code, instructions, and the like that is to be executed by the processor 22.

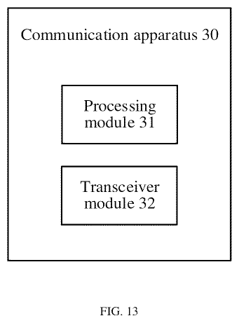

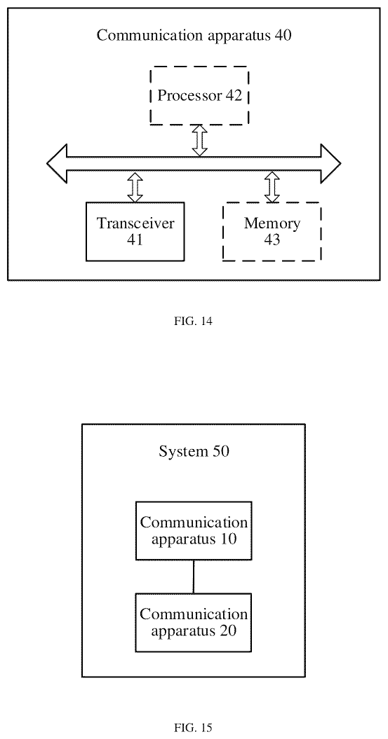

FIG. 13 is a schematic block diagram of a communication apparatus 30 according to an embodiment of the present application. As shown in FIG. 13, the communication apparatus 30 includes:
a processing module 31, configured to obtain Q reference distribution(s) corresponding to Q layer(s) of a first AI model, where the Q reference distribution(s) is configured to obtain a second AI model, and Q is a positive integer; and
a transceiver module 32, configured to send first information indicating the Q reference distribution(s).

The communication apparatus 30 in this embodiment of the present application may correspond to the second network element in the communication method in the embodiments of the present application described above, and the management operations and/or functions and other management operations and/or functions of modules of the communication apparatus 30 are intended to implement corresponding steps of the foregoing methods. For brevity, details are not described herein again.

The processing module 31 in this embodiment of the present application may be implemented by a processor. The transceiver module 32 in this embodiment of the present application may be implemented by a transceiver.

As shown in FIG. 14, a communication apparatus 40 may include a transceiver 41. Optionally, the communication apparatus 40 may further include a processor 42 and/or a memory 43. The memory 43 may be configured to store indication information, or may be configured to store code, instructions, and the like that is to be executed by the processor 42.

The processor 22 or the processor 42 may be an integrated circuit chip and have a signal processing capability. In an embodiment process, steps in the foregoing method embodiments can be implemented by using a hardware-integrated logical circuit in the processor, or by using instructions in the form of software. The processor 22 or the processor 42 may be a general-purpose processor, a digital signal processor (DSP), an application-specific integrated circuit (ASIC), a field programmable gate array (FPGA), or another programmable logic device, a discrete gate or a transistor logic device, or a discrete hardware component. All methods, steps, and logical block diagrams disclosed in this embodiment of the present application may be implemented or performed. The general-purpose processor may be a microprocessor, or the processor may be any conventional processor or the like. Steps of the methods disclosed in the embodiments of the present invention may be directly performed and completed by a hardware decoding processor or may be performed and completed by using a combination of hardware and software modules in the decoding processor. The software module may be located in a storage medium known in the art, such as a random access memory, a flash memory, a read-only memory, a programmable read-only memory, an electrically erasable programmable memory, or a register. The storage medium is located in the memory, and the processor reads the information in the memory and completes the steps in the foregoing methods in combination with the hardware of the processor.

It may be understood that the memory 23 or the memory 43 in the embodiments of the present invention may be a volatile memory or a non-volatile memory or may include a volatile memory and a non-volatile memory. The non-volatile memory may be a read-only memory (ROM), a programmable read-only memory (PROM), an erasable programmable read-only memory (EPROM), an electrically erasable programmable read-only memory EEPROM), or a flash memory. The volatile memory may be a random access memory (RAM) and may be used as an external cache. Through example but not limitative description, many forms of RAMs may be used, for example, a static random access memory (SRAM), a dynamic random access memory (DRAM), a synchronous dynamic random access memory SDRAM), a double data rate synchronous dynamic random access memory (DDR SDRAM), an enhanced synchronous dynamic random access memory (Enhanced SDRAM, ESDRAM), a synchronous link dynamic random access memory (SLDRAM), and a direct rambus dynamic random access memory (DR RAM). The storage of the system and the method described in this specification aim to include, but are not limited to, these and any other proper storage.

An embodiment of the present application further provides a system. As shown in FIG. 15, a system 50 includes:
the communication apparatus 10 according to the embodiments of the present application and the communication apparatus 20 according to the embodiments of the present application.

An embodiment of the present application further provides a computer storage medium, and the computer storage medium may store one or more program instructions for executing any of the foregoing methods.

Optionally, the storage medium may be specifically the memory 23 or 43.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of the present application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in the present application, the disclosed system, apparatus, and method may be implemented in other manners. For example, the described apparatus embodiment is merely an example. For example, the unit division is a logical function division, and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit or may be distributed among a plurality of network units. Some or all of the units may be selected based on actual requirements to achieve the objectives of the embodiments.

In addition, function units in the embodiments of the present application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of the present application may be implemented in the form of a software product. The software product is stored in a storage medium, and includes several instructions for instructing a computer device (which may be a personal computer, a server, a network device, or the like) to perform all or some of the steps of the methods described in the embodiments of the present application. The foregoing storage medium includes any medium that can store program code, such as a USB flash drive, a removable hard disk, a read-only memory (Read-Only Memory, ROM), a random access memory (Random Access Memory, RAM), a magnetic disk, an optical disc or the like.

The foregoing descriptions are merely specific embodiments of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

1. A method, comprising:
receiving first information indicating Q reference distribution(s) corresponding to Q layer(s) of a first artificial intelligence (AI) model, wherein Q is a positive integer; and
obtaining a second AI model based on q reference distribution(s) in the Q reference distribution(s), wherein q is a positive integer, and q≤Q.

2. The method according to claim 1, wherein the obtaining the second AI model based on the q reference distribution(s) in the Q reference distribution(s) comprises:
obtaining the second AI model with one or more regularizations configured to minimize difference(s) between the q reference distribution(s) and distribution(s) of corresponding q layer(s) of the second AI model.

3. The method according to claim 2, further comprising:
sending second information indicating optimization result(s) of the one or more regularizations.

4. The method according to claim 1, wherein the Q layer(s) comprises one or more latent layers of the first AI model.

5. The method according to claim 1, further comprising:
receiving third information indicating the Q layer(s).

6. The method according to claim 1, further comprising:
receiving fourth information indicating Q scoring function(s) configured to measure difference(s) between the Q reference distribution(s) and distribution(s) of the Q layer(s).

7. An apparatus, comprising:
at least one processor coupled with a memory storing instructions that, when executed by the at least one processor, cause the apparatus to perform operations, wherein the operations comprise:
receiving first information indicating Q reference distribution(s) corresponding to Q layer(s) of a first AI model, wherein Q is a positive integer; and
obtaining a second AI model based on q reference distribution(s) in the Q reference distribution(s), wherein q is a positive integer, and q≤Q.

8. The apparatus according to claim 7, wherein the obtaining the second AI model based on the q reference distribution(s) in the Q reference distribution(s) comprises:
obtaining the second AI model with one or more regularizations configured to minimize difference(s) between the q reference distribution(s) and distribution(s) of corresponding q layer(s) of the second AI model.

9. The apparatus according to claim 8, the operations further comprising:
sending second information indicating optimization result(s) of the one or more regularizations.

10. The apparatus according to claim 7, wherein the Q layer(s) comprises one or more latent layers of the first AI model.

11. The apparatus according to claim 7, the operations further comprising:
receiving third information indicating the Q layer(s).

12. The apparatus according to claim 7, the operations further comprising:
receiving fourth information indicating Q scoring function(s) configured to measure difference(s) between the Q reference distribution(s) and distribution(s) of the Q layer(s).

13. The apparatus according to claim 8, wherein minimizing the difference(s) comprises minimizing the difference(s) based on Kullback-Leibler (KL) divergence, Jensen-Shannon (JS) distance, or Wasserstein distance.

14. An apparatus, comprising:
at least one processor coupled with a memory storing instructions that, when executed by the at least one processor, cause the apparatus to perform operations, wherein the operations comprise:
obtaining Q reference distribution(s) corresponding to Q layer(s) of a first artificial intelligence (AI) model, wherein the Q reference distribution(s) is configured to obtain a second AI model, and Q is a positive integer; and
sending first information indicating the Q reference distribution(s).

15. The apparatus according to claim 14, wherein the Q reference distribution(s) is configured to set up one or more regularizations configured to minimize difference(s) between the Q reference distribution(s) and distribution(s) of corresponding q layer(s) of the second AI model.

16. The apparatus according to claim 15, the operations further comprising:
receiving second information indicating optimization result(s) of the one or more regularizations.

17. The apparatus according to claim 14, wherein the Q layer(s) comprises one or more latent layers of the first AI model.

18. The apparatus according to claim 14, the operations further comprising:
sending third information indicating the Q layer(s).

19. The apparatus according to claim 14, the operations further comprising:
sending fourth information indicating Q scoring function(s) configured to measure difference(s) between the Q reference distribution(s) and distribution(s) of the Q layer(s).

20. The apparatus according to claim 15, wherein the difference(s) is minimized based on Kullback-Leibler (KL) divergence, Jensen-Shannon (JS) distance, or Wasserstein distance.
